(19) United States
(12) Patent Application Publication
(10) Pub. No.: US 2006/0266965 A1
(43) Pub. Date: Nov. 30, 2006

(54) Electromagnetically actuated pivot valve assembly

(76) Inventors: William F. Everett, Goshen, IN (US); Scott B. McAfoos, Elkhart, IN (US)

Correspondence Address: Ryan M. Fountain, Esq., 420 Lincoln Way West, Mishawaka, IN, 46544, US

(21) Appl. No.: 11/135,722

(22) Filed: May 25, 2005

(51) Int. Cl. F16K 31/02

(52) U.S. Cl. 251/129.02

(57) ABSTRACT

An electromagnetically actuated valve is provided formed from three elements, an armature pivot assembly forming a poppet valve member and encapsulated in thermoplastic material, a first body member forming one part of a valve chamber with the valve seat to a fluid port and including an encapsulated solenoid, and a second body member forming another part of a valve chamber for containing the poppet valve member relative to another fluid port. The solenoid operates to pivot the poppet valve member. The fluid flowing through the valve is isolated from metallic components, magnet flux and heat. The assembly is of simplified construction and maintenance.

### BACKGROUND AND SUMMARY OF THE INVENTION

The present invention relates generally to electromagnetically actuated valves and, more particularly, to such valves for use in fluid metering of beverages or medical applications.

Previously, typical fluid metering valves used specifically in beverage or medical applications have the electrical and electromagnetic actuation means isolated from the flow path or the fluid that is being controlled. This is has been done for several reasons, such as to obtain corrosion resistance, avoid fluid contamination, establish electrical isolation, provide moisture containment or actuator exclusion from the controlled fluid itself or from external condensation, and to reduce heat transfer to or from the controlled fluid.

Among the most common means to achieve this isolation is to use a solenoid that has a sealed and wetted core area, where the controlled fluid is in contact with the moving armature and inside bore of the solenoid. An example of this is shown in U.S. Pat. 6,328,181.

An alternative means to achieve this fluid isolation is to separate the solenoid actuator from the valve porting by using a lever mechanism. In this alternate configuration, a linear actuated solenoid operates a lever, which in turn operates a poppet and seal arrangement. Examples of this are shown in U.S. Pat. Nos. 4,250,919, 4,285,497, 4,741,355, 5,607,083 and 5,799,696.

In all of these prior arrangements, the objective has been to utilize a linear actuated solenoid operator to affect a motion to open and close a valve port, either by direct port operation (U.S. Pat. No. 6,328,181) or by a lever action attached to a linear actuated solenoid (the other above-referenced patents). In each of these cases, there exists an armature that is actuated by the solenoid that slides linearly in a cylindrical bore.

In dealing with the limitations of such prior arrangements, commercial embodiments have typically employed two valves as a failsafe in case mineral build up, calcium for example, blocks one of the valves.

Accordingly, it is an object of the present invention to provide an improved electromagnetically actuated valve assembly, particularly one suited for beverage or medical fluid metering applications. Other objects include the provision of an electromagnetically actuated valve which:
a. is of simplified construction and can be inexpensively manufactured,
b. avoids the need for machined steel parts, such as an armature or pole piece,
c. is operable with a low average continuous power,
d. avoids heat contribution to the fluid being metered,
e. avoids metal contact with the fluid being metered,
f. is readily adaptable in size for various pressure, volume and electrical power requirements in given applications, and
g. is more easily serviceable in the field.

These and other objects of the present invention are obtained by the provision of an electromagnetically actuated valve with a pivoting lever mechanism to directly operate a valve poppet seal assembly to meter the fluid flow, wherein the valve assembly includes an encapsulated electromagnetic actuator body assembly, an armature pivot assembly and an inlet body, the encapsulated electromagnetic actuator body assembly being formed as an integral part of the complete valve assembly with thermoplastic encapsulation of all metal elements forming the magnetic circuit and isolation of the metal from the fluid flow path. The armature pivot assembly is integrally formed with the valve seal and also isolates metal from the fluid flow path.

Other objects, advantages and novel features of the present invention will be readily apparent from the following detailed description of the preferred embodiments and from the attached drawings.

### BRIEF DESCRIPTION OF THE DRAWINGS

FIG. 1 shows a top, left perspective view of a valve assembly incorporating the present invention.

FIG. 2 shows a top view of the valve assembly of FIG. 1.

FIG. 3 shows a cross sectional view along line Z-Z of FIG. 2 of the valve assembly of FIG. 1.

FIG. 4 shows a cross sectional view along line Y-Y of FIG. 2 of the valve assembly of FIG. 1.

FIG. 5 shows a top, left perspective view of the armature pivot assembly of the valve assembly of FIG. 1.

### DETAILED DESCRIPTION OF THE PREFERRED EMBODIMENTS

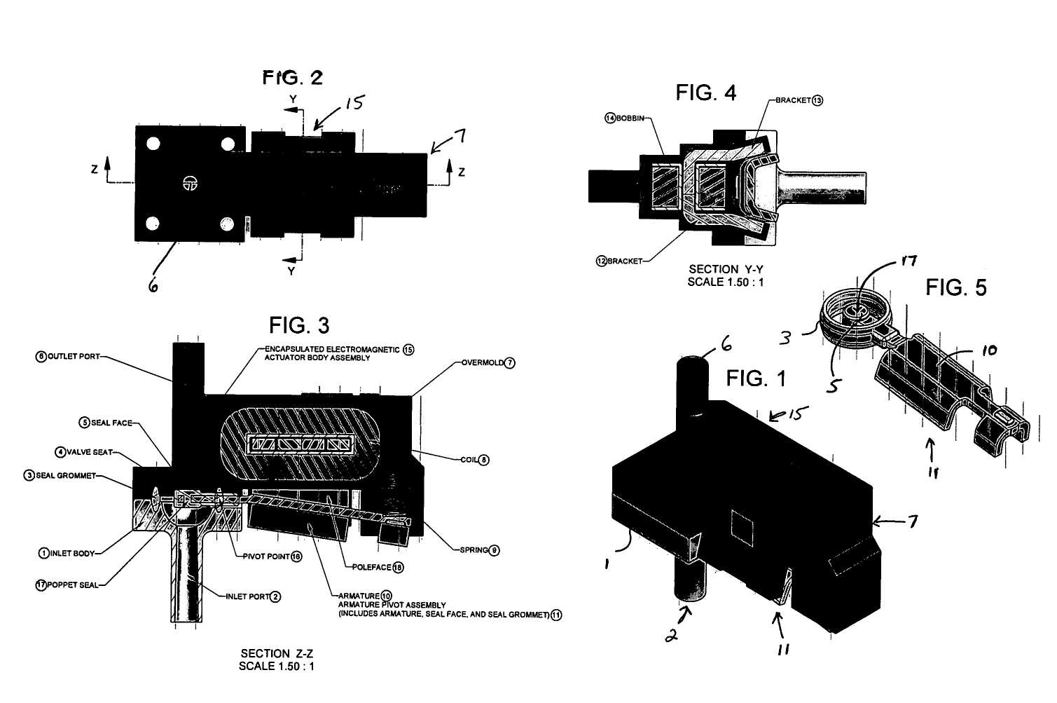

FIG. 1 shows a preferred embodiment of the present invention in an application for metering beverage fluids. The present invention is also immediately applicable to a variety of other applications, such as controlling the flow of medical fluids. These applications of the present invention can be referred to as an “EPV” (Electromagnetic Pivot Valve) and are generally an electromagnetically actuated valve with a pivoting lever mechanism to directly operate a valve poppet seal assembly, and thereby affecting a shutoff of flow in a control valve.

The EPV includes a shutoff valve assembly having three major elements: the encapsulated electromagnetic actuator body assembly (EABA) (15), the armature pivot assembly (11), and the inlet body (1). The armature pivot assembly (11) is comprised of the armature (10), the thermoplastic elastomer overmold that forms the seal face (5), the poppet seal (17), the seal grommet (3) and the pivot point (16).

The EABA (15) forms an integral element of the complete valve assembly, and provides thermoplastic encapsulation of all stationary metal elements forming the magnetic circuit, and provides isolation of the metal from the flow path of the control valve. The EABA is, for example, made up of the wound coil (8) and bobbin (14), the brackets (12) & (13), and the thermoplastic overmold (7) which also forms the normally closed valve seat (4) and the outlet port (6). The entire stationary portion of the magnetic circuit is, in the example shown, made up of brackets (12) & (13). Although thermoplastic encapsulation is shown in the drawings, in other embodiments various other elastomer materials can be used according to the environmental and economic needs of particular applications.

In especially preferred embodiments, the armature pivot assembly (11) forms the only moving element of the valve in the magnetic circuit. An electrical signal applied to the coil (8) causes a magnetic field to be established in the magnetic circuit formed by the brackets (12) & (13) and the armature pivot assembly (11). The armature pivot assembly (11) is attracted towards the polefaces (18) of the brackets (12) & (13). The poppet seal (17) pivots about a point (16) in the seal grommet (3). The seal face (5) moves away from the valve seat (4) opening the valve and allowing the controlled fluid to pass through the valve assembly from the inlet port (2) to the outlet port (6). Upon removal of the electrical signal applied to the coil (8), the return spring (9) moves the armature pivot assembly (11) away from the polefaces (18), causing the poppet seal (17) to pivot, closing the seal face (5) and valve seat (4). In the de-energized state, the spring (9) maintains the EPV valve in the “closed position”.

In the operation of the EPV valve assembly, the controlled fluid moving from the inlet port (2) to the outlet port (6) is in intimate contact with only the inlet body (1), the material used to encapsulate the armature (10) and form the poppet seal (17) and the seal grommet (3), and the material used to encapsulate the EABA (15). The outlet port (6) is created as a part of the thermoplastic overmold (7) when fabricated as a complete EABA (15). The exterior of the inlet port (2) and the outlet port (6) as shown in the drawings to have a relatively smooth surface for connection to conventional fluid conduits according to the particular applications of use. However, it should be readily understood that these surfaces could, alternatively, be threaded or otherwise formed to facilitate whatever connection means is desired in a given application.

In contrast with prior assemblies, in the operation of the EPV no sliding action occurs between moving components. Accordingly, no friction or linear drag is created to cause mechanical wear. All mechanical action is in the rotation of the armature pivot assembly (11) about the pivot point (16). Configuration of the poleface (18) formed by the unique arrangement of the brackets (12) & (13) affects a force imparted by the electromagnetic attraction of the polefaces (18) and the armature (10) so as to result in a pure moment about pivot point (16). Further, the spring (9) is also creating a moment about pivot point (16) that results in the return force to the un-energized state.

In the application of electrical power to the coil (8), such as by a pulse width modulation (PWM) signal, that signal can, for example, be provided by a commonly available digital driver microcircuit, subsequently driving an Infineon BTS117 HITFET device or equivalent. The common description of a pulsed digital electrical signal is called pulse width modulation (PWM), which would be provided by the digital microcircuit and amplified by the HITFET. This allows for a large magnetizing force to be applied to the magnetic circuit (10, 12, and 13) initially, by a 100% pulse width signal then reduced to a holding signal after valve actuation. The holding signal is typically 30% or less of the full PWM signal. The magnetic permeance across the air gap between the poleface (18) and the armature (10) changes significantly as the gap closes and the poppet seal rotates. At the closed gap position, the permeance across the gap is significantly lower than even a traditional solenoid, because of the poleface area of the EPV. This typically results in a significantly lower electrical holding signal (as a percentage of the PWM). In a traditional prior solenoid actuator, the ratio of flux conductor (armature or polepiece) and the poleface area is, for example, one to one (1:1). In the EPV, the ratio of the flux conductors (brackets (12) & (13)) and the poleface (18) area is approximately 1:4.

Since the “poleface” area of the EPV is unique compared to a traditional solenoid, the open gap actuating force and the closed gap hold force afford the opportunity to create a higher pull-in force at the “pulse” actuation, and a hold-in force at the closed with a “hold” current (or power level) less than that of a traditional solenoid. The end result of these features allows for an electromagnetic actuator assembly that creates the same characteristics of valve operation as a traditional prior solenoid, yet can be made in a smaller solenoid package size, and therefore at significantly less cost.

Further, the low power dissipation of the present invention permits no significant heat contribution to the fluid being metered. The magnetic materials are not a part of the valve wetted flow area and do not come in contact with any controlled flow. Typical solenoid valve actuators have a stationary polepiece and a moving armature that are in intimate contact with the controlled flow. Eddy current heating in the magnetic steels from AC magnetic fields, and “I²R” resistive heating in AC and DC coils due to current through the coil creates heat loss that is transferred into the controlled fluids. This is a common and undesirable condition in a typical prior direct acting solenoid valve configuration. Alternative prior arrangements to minimize heat transfer problems have required significantly more complicated assemblies.

The pivot actuation of the solenoid of the present invention provides considerable advantage over prior systems. No secondary link or mechanism is required as compared with prior linear solenoid actuated valves. The molded pivot actuator provides a mechanical advantage from the electromagnetic actuator assembly to the poppet seal assembly and port face. Therefore the magnetic force generated at the working gap (pivot actuator to bracket gap) can be multiplied to increase the force available at the seal and port interface. This mechanical advantage allows the electromagnetic actuator assembly to be smaller, compared to a solenoid required to generate the same port / seal force in a direct acting manner. The initial electrical pulse at actuation compensates for the fact that the working gap of the EPV is greater than a comparable direct acting solenoid.

In the present invention, the fluid flow path is isolated. Only thermoplastic and elastomer are in contact with the control flow. No armature or polepiece is in the flow path, so there is no metal corrosion or fluid contamination due to metal corrosion or chemical reaction with the controlled fluid. The particular thermoplastic or elastomer materials used in a given application can be any number of such materials as may be required by the FDA or NSF or the end user.

Further, valve assemblies according to the present invention can be mounted in line or to the manifold of the overall product into which the valve assembly is incorporated without prior calibration due to the integrated encapsulated actuator assembly. Also, the integration of components permitted by the present invention can greatly simplify field service and repair with interchangeable elements. Also, the brackets of the present invention can be formed from stamped metal, as compared to the screw machine formed polepiece and armatures of prior devices. This can result in significant cost savings in manufacture. Also, the stamped brackets may be fabricated from common magnetic carbon steels that do not need to be non-corrosive (such as 430 stainless) nor require unique plating or chemical treatments to render them non-corrosive in the controlled fluid.

Although the present invention has been described above in detail with respect to particular preferred embodiments, that is by way of illustration and example only. The spirit and scope of the present invention are limited only by the terms of the claims below.

What is claimed is:

1. An electromagnetically actuated valve assembly for controlling the flow of fluid, comprising:
a body having a fluid inlet and a fluid outlet with a valve therebetween,
the valve having a valve seat and a pivotally actuated poppet member,
a pivotally actuating solenoid for controlling the motion of the poppet member into and out of engagement with the valve seat, and
means for isolating metal components, heat and magnetic flux of the solenoid from the fluid flowing between the inlet and the outlet.

2. The assembly according to claim 1 wherein the poppet member forms the armature of the solenoid.

3. The assembly according to claim 2 wherein the assembly includes a seal member about the poppet member which is integrally formed with the poppet member.

4. The assembly according to claim 3 wherein the poppet member is encapsulated in an elastomer material.

5. The assembly according to claim 1 where in the solenoid comprises a coil and a core that is encapsulated in the assembly body.

6. The assembly according to claim 1 wherein the solenoid comprises a coil and pole faces that are fixed with respect to the valve body and an armature what is pivotably mounted with respect to the coil.

7. A solenoid for controlling fluid flow through a valve wherein the armature of the solenoid actuates by a pivoting motion.

8. An electromagnetically actuated valve assembly wherein the valve housing, a solenoid coil and solenoid pole faces are all fixed with respect to each other.

9. The assembly according to claim 8 wherein the valve housing and solenoid coil are embedded in a thermoplastic material.

10. The assembly according to claim 9 wherein an armature of the solenoid is included for actuating the valve and wherein the armature is pivotably mounted with respect to the armature coil.
